(19) United States
(12) Patent Application Publication
(10) Pub. No.: US 2015/0325176 A1
(43) Pub. Date: Nov. 12, 2015

(54) IMAGE DISPLAY APPARATUS, IMAGE DISPLAY METHOD, AND PROGRAM

(71) Applicant: Sharp Kabushiki Kaisha, Osaka-shi, Osaka (JP)

(72) Inventor: Daisuke KOYAMA, Osaka-shi (JP)

(73) Assignee: Sharp Kabushiki Kaisha, Osaka-shi, Osaka (JP)

(21) Appl. No.: 14/388,903

(22) PCT Filed: Apr. 8, 2013
(86) PCT No.: PCT/JP2013/060581

§ 371 Date: Sep. 29, 2014

(30) Foreign Application Priority Data
May 14, 2012 (JP) 2012-110665

(51) Int. Cl. G09G 3/34

(52) U.S. Cl. CPC G09G 3/3406; G09G 2320/0646; G09G 2360/16; G09G 2330/00

(57) ABSTRACT

The purpose is to reduce power consumption of an image display apparatus. An image display apparatus includes a display panel (17); a light source (11) that irradiates the display panel (17); and a control unit (5). When a picture signal input to the image display apparatus is displayed on the display panel and controlled to have a target display brightness, the control unit modifies the amount of light emitted by the light source and performs picture signal brightness correction so as to compensate for the modification of the light source luminance. When the amount of change in light source luminance is smaller than a threshold value, the control unit (5) decreases the light source luminance without performing the picture signal brightness correction.

### TECHNICAL FIELD

The present invention relates to image display technology.

### BACKGROUND ART

In a conventional image display apparatus, such as a portable terminal or a television receiver apparatus, that uses a non-light emitting display device like a liquid crystal panel as a display unit, electric power supplied from a battery is converted by a light source (such as a cold-cathode tube or an LED) into light, and the amount of light passed through the liquid crystal panel is controlled for display. Generally, of the entire power consumed by the image display apparatus, the ratio of power consumed by the light source is large. Thus, during battery drive, the amount of light emitted by the light source is decreased so as to reduce the power consumption by the apparatus as a whole.

When the amount of light is reduced, visibility also decreases as a result of a decrease in luminance of the screen as a whole. Accordingly, there is a need for a technology capable of achieving both a decrease in power consumption by lowering the amount of light and maintenance of visibility.

Patent Literature 1 indicated below discloses a liquid crystal display apparatus in which the backlight luminance is dynamically changed in accordance with an input image luminance distribution. In this apparatus, the decrease in apparent brightness due to a decrease in backlight luminance (dimming) is compensated by an image data conversion process (brightness correction), thus saving electric power while maintaining image quality.

Some of the latest liquid crystal displays are built inside their panels with a memory for storing image data (see Patent Literature 2 below). According to this technology, the display data supplied to the display means comprising pixels for providing a display is written by a write means to the display data storage means and stored therein. The display data stored in the display data storage means is read by a read means 4 and supplied for display.

Thus, when earlier displayed data and subsequently displayed data are identical or almost identical, the earlier displayed data stored in the display data storage means can be utilized, whereby power consumption can be decreased.

By the configuration according to Patent Literature 2, the need for transmitting data can be eliminated except when the image data content has been changed, thus reducing power consumption by the corresponding amount.

### CITATION LIST

### Patent Literature

Patent Literature 1: JP 2006-308632 A

Patent Literature 2: JP 07-072511 A

### SUMMARY OF THE INVENTION

### Technical Problem

However, when, for example, the backlight control method according to Patent Literature 1 is applied to a liquid crystal display of the type used for the technology of Patent Literature 2, new image processing and a new image data transmission process become necessary due to a change in the image data caused by brightness correction. As a result, the decrease in power consumption achieved by the backlight luminance control may be cancelled out by an increase in power consumption due to the image data transmission, creating the problem of a potential increase in power consumption.

The purpose of the present invention is to reduce power consumption of an image display apparatus.

### Solution to the Problem

According to an aspect of the present invention, an image display apparatus includes a display panel; a light source that irradiates the display panel; and a control unit. When a picture signal input to the image display apparatus is displayed on the display panel and controlled to have a target display brightness, the control unit modifies the amount of light emitted by the light source (hereafter referred to as “light source luminance”) and performs picture signal brightness correction so as to compensate for the modification of the light source luminance. When the amount of change in light source luminance is smaller than a threshold value, the control unit decreases the light source luminance without performing the picture signal brightness correction.

In the image display apparatus, when the amount of change in light source luminance is smaller than the threshold value, the light source luminance is decreased without performing picture signal brightness correction. Thus, a process burden caused by performing the picture signal brightness correction even when the amount of change in light source luminance is small can be decreased. The threshold value may be such that the display is not difficult to view even without performing brightness correction in response to a decrease in the amount of light of the light source.

Preferably, when the amount of change in light source luminance is greater than the threshold value, the control unit may decrease the light source luminance and perform the picture signal brightness correction.

The light source luminance may be modified for a period depending on the amount of change in light source luminance. In this case, the brightness correction is performed only when the amount of change is more than the threshold value with reference to the light source luminance at the point in time when brightness correction was performed last. Thus, the number of times of the brightness correction process can be decreased.

The threshold value may be variable depending on a current light source luminance value.

In this example, it is contemplated that the backlight luminance change threshold value for determining whether brightness correction is to be performed is varied in accordance with the current backlight luminance value.

Particularly, by increasing the threshold value when the light source luminance value is large and by decreasing the threshold value when the light source luminance value is small, better appearance can be obtained. Correction is avoided in the case of high luminance because not much of a power saving effect can be obtained, while in the case of low luminance the correction process and the like may be performed and yet a balance can be achieved because a sufficient power saving effect can be obtained.

Preferably, the display panel may be provided with a memory for holding picture data. This configuration is particularly effective in a configuration involving a process of transmitting picture data to a memory.

A picture signal output unit may be provided with a memory for holding picture data so that a change in the picture signal and a change in the light source luminance can be output in a synchronized manner.

According to another aspect of the present invention, an image display method in an image display apparatus including a display panel and a light source that irradiates the display panel includes a control step of, when a picture signal input to the image display apparatus is displayed on the display panel and controlled to have a target display brightness, modifying the amount of light emitted by the light source and performing picture signal brightness correction so as to compensate for the modification of the light source luminance. The control step includes a step of decreasing the light source luminance without performing the picture signal brightness correction when the amount of change in light source luminance is smaller than a threshold value.

The present invention may include a program for causing a computer to execute the image display method, and a computer-readable recording medium in which the program is recorded.

The present specification includes the contents of the specification and/or drawings of the Japanese patent application No. 2012-110665 as a basis of priority claimed by the present application.

### Advantageous Effects of Invention

According to the present invention, power consumption of an image display apparatus can be decreased.

### BRIEF DESCRIPTION OF THE DRAWINGS

FIG. 1 is a functional block diagram of a configuration example of an image display apparatus according to an embodiment of the present invention.

FIG. 2 is a detailed functional block diagram of a configuration example of a control unit.

FIG. 3 is a flowchart illustrating the flow of image processing and a display process according to an embodiment of the present invention.

FIG. 4 is an operational chart illustrating an example of changes over time in an input image, backlight (light source) luminance, brightness correction, and apparent brightness in accordance with a process according to the conventional technology corresponding to a first embodiment of the present invention.

FIG. 5 is an operational chart illustrating an example of changes over time in an input image, backlight (light source) luminance, brightness correction, and apparent brightness in accordance with a process according to the first embodiment of the present invention.

FIG. 6 is an operational chart illustrating an example of changes over time in an input image, backlight (light source) luminance, brightness correction, and apparent brightness in accordance with a process according to a second embodiment of the present invention.

FIG. 7 is an operational chart illustrating an example of changes over time in an input image, backlight (light source) luminance, brightness correction, and apparent brightness in accordance with a process according to the conventional technology corresponding to the second embodiment of the present invention.

FIG. 8 is an operational chart illustrating an example of changes over time in an input image, backlight (light source) luminance, brightness correction, and apparent brightness in accordance with a process according to a third embodiment of the present invention.

FIG. 9 is an operational chart illustrating an example of changes over time in an input image, backlight (light source) luminance, brightness correction, and apparent brightness in accordance with a process according to the conventional technology corresponding to the third embodiment of the present invention.

FIG. 10 is an operational chart illustrating an example of changes over time in an input image, backlight (light source) luminance, brightness correction, and apparent brightness in accordance with a process according to a fourth embodiment of the present invention.

FIG. 11 is an operational chart illustrating an example of changes over time in an input image, backlight (light source) luminance, brightness correction, and apparent brightness in accordance with a process according to the conventional technology corresponding to the fourth embodiment of the present invention.

### DESCRIPTION OF EMBODIMENTS

In the following, an image display technology according to an embodiment of the present invention will be described with reference to the drawings.

### First Embodiment

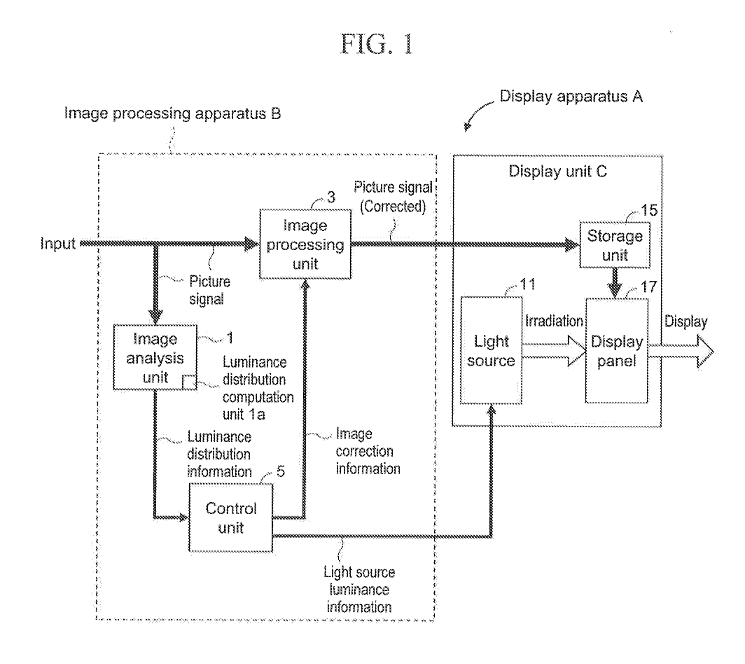

FIG. 1 is a functional block diagram illustrating a configuration example of an image display apparatus according to an embodiment of the present invention. As shown in FIG. 1, a display apparatus A according to the present embodiment includes an image processing apparatus B and a display unit C. The image processing apparatus B includes an image analysis unit 1, an image processing unit 3, and a control unit 5. The image analysis unit 1 includes a luminance distribution computation unit 1a that computes a luminance distribution of an input picture signal. The image analysis unit 1 receives the picture signal as an input and sends luminance distribution information to the control unit 5. The image processing unit 3 receives the picture signal as an input and sends the picture signal after image processing including a correction process to the display unit C. The control unit 5 receives the luminance distribution information, and sends image correction information to the image processing unit 3 and light source luminance information to the display unit C.

The display unit C includes a light source 11, a storage unit 15, and a display panel 17. The light source 11 irradiates the display panel with light based on the luminance information from the control unit 5. The storage unit 15 stores the picture signal from the image processing unit 3, and sends the stored picture signal to the display panel 17. The picture signal is stored on a pixel by pixel basis, for example.

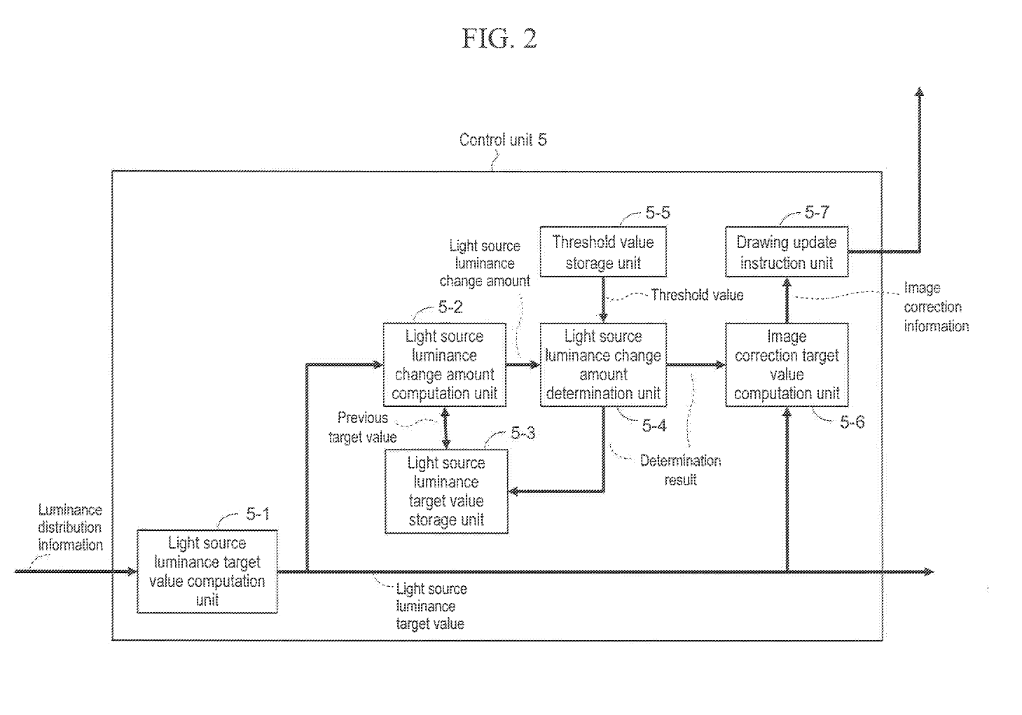

FIG. 2 is a detailed functional block diagram illustrating a configuration example of the control unit 5. As shown in FIG. 2, the control unit 5 includes a light source luminance target value computation unit 5-1 that computes a light source luminance target value; a light source luminance change amount computation unit 5-2 that computes an amount of change in light source luminance; a light source luminance target value storage unit 5-3 that stores the light source luminance target value; a light source luminance change determination unit 5-4 that determines a change in light source luminance; a threshold value storage unit 5-5 that stores a threshold value for the amount of change in light source luminance; an image correction target value computation unit 5-6 that computes an image correction target value; and a drawing update instruction unit 5-7 that provides a drawing update instruction. The threshold value may be set to an arbitrary value. The threshold value storage unit 5-5 may be provided at a position other than the control unit 5 in the image processing apparatus B.

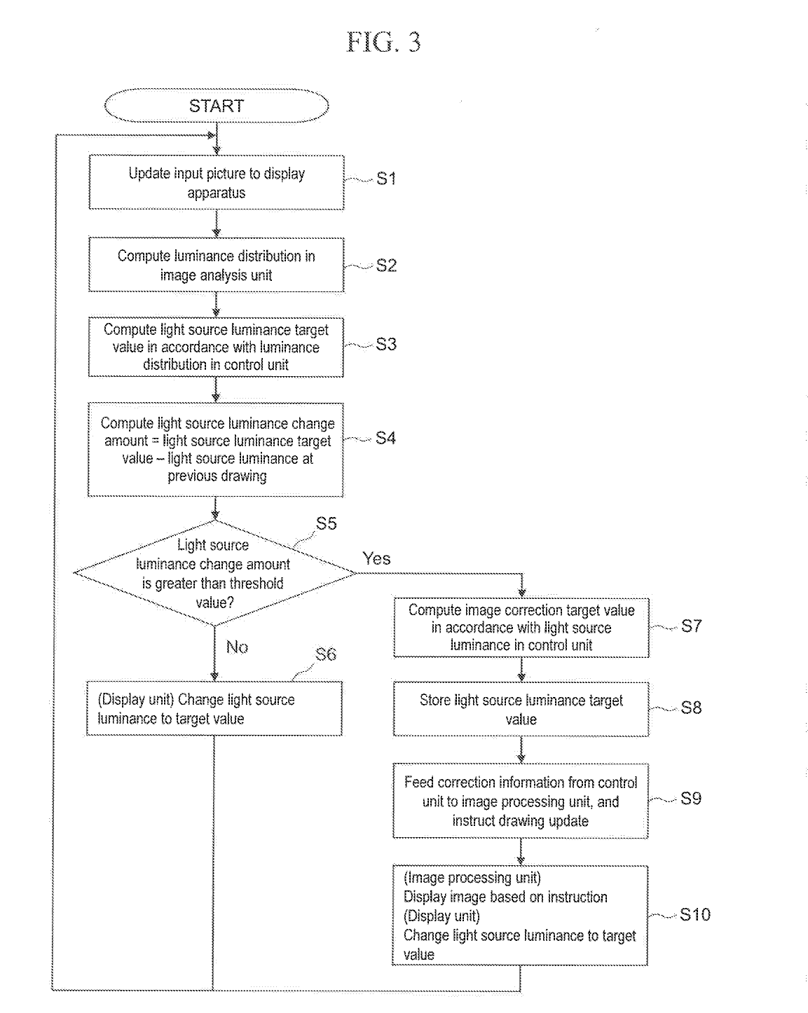

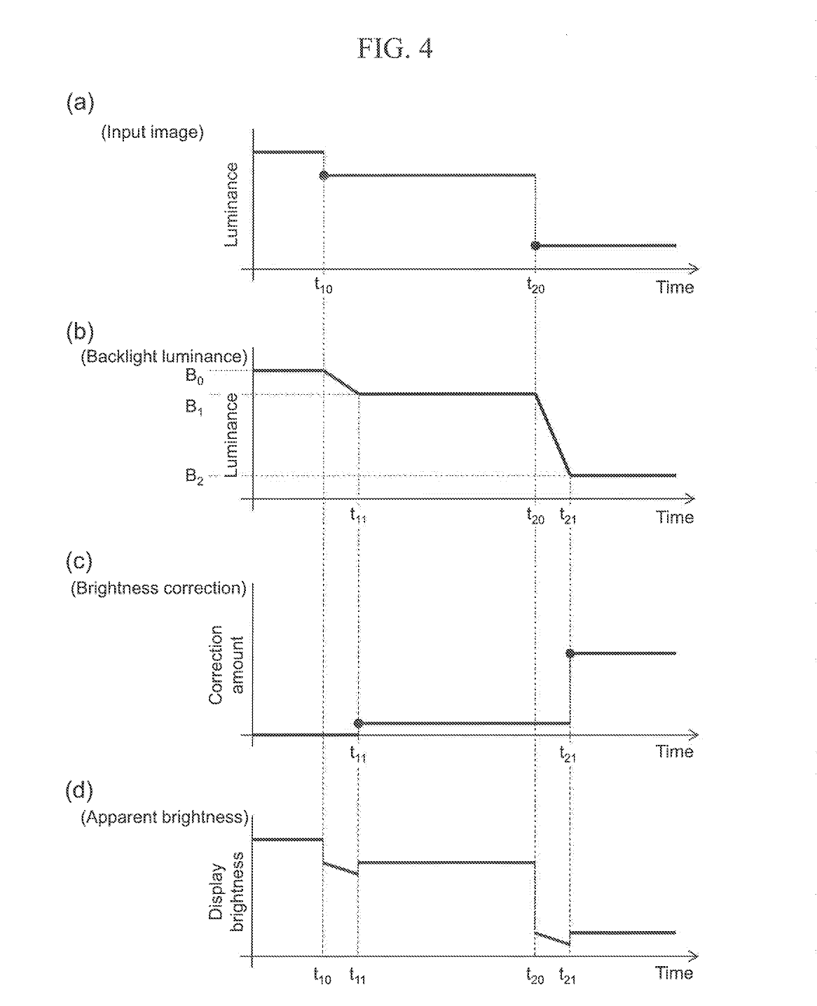

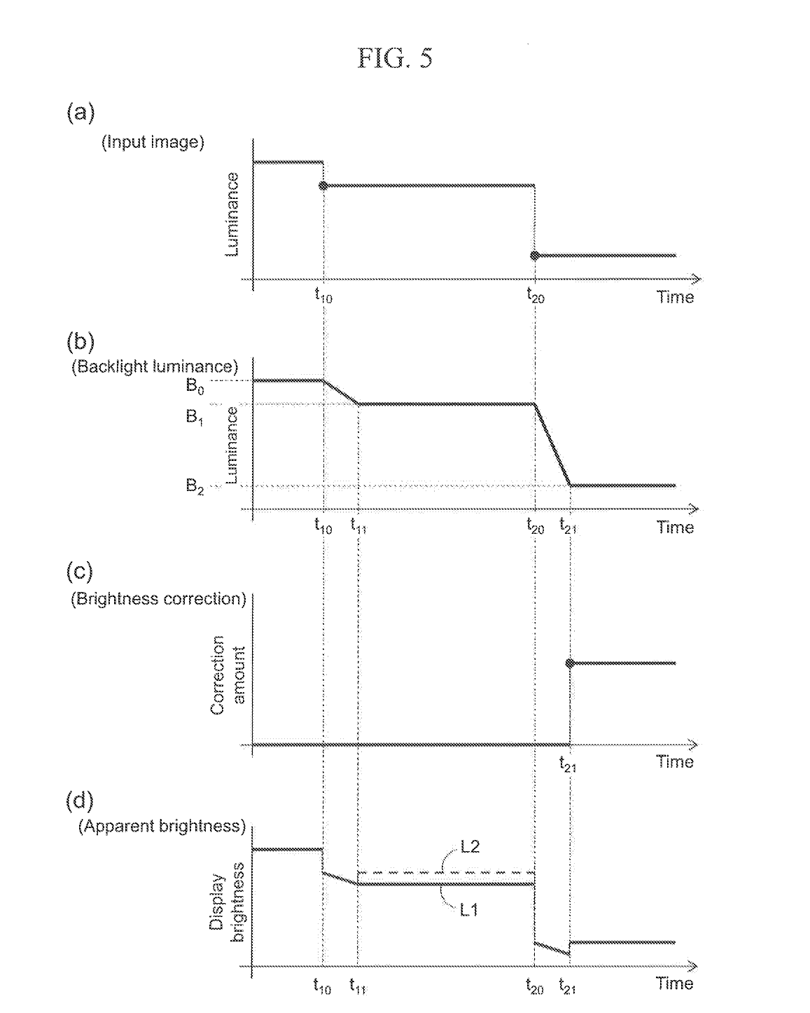

FIG. 3 is a flowchart illustrating the flow of image processing and a display process according to the present embodiment. FIG. 4 is an operational chart illustrating an example of changes over time in an input image, backlight (light source) luminance, brightness correction, and apparent brightness in accordance with the process according to the conventional technology. FIG. 5 is an operational chart illustrating an example of changes over time in an input image, backlight (light source) luminance, brightness correction, and apparent brightness in accordance with the process according to the present embodiment.

As shown in FIG. 3, the process is started (START) and in step S1, an input image to the display apparatus A is updated. In step S2, the image analysis unit 1 computes a luminance distribution of the input image. In step S3, the light source luminance target value computation unit 5-1 of the control unit 5 computes a light source luminance target value B1 corresponding to the luminance distribution. In step S4, the light source luminance change amount computation unit 5-2 subtracts from the light source luminance target value computed in step S3 a light source luminance target value for the previous correction (hereafter referred to as a “previous target value”), thus computing an amount of change in light source luminance.

It is assumed that in a period before the initial image correction is performed, an initial value B0 of light source luminance is saved as the previous target value.

Thereafter, in step S5, the light source luminance change amount determination unit 5-4 determines whether the amount of change in light source luminance is more than the threshold value stored in the threshold value storage unit 5-5 (hereafter referred to as “the threshold value”). If the amount of change in light source luminance (B1-B0) corresponding to an input image luminance change indicated at time t₁₀ in FIG. 5(a) is so small as to be not more than the certain threshold value (No), the process goes on to step S6, where the brightness of the light source 11 in the display unit C is modified to a light source luminance target value B1 computed by the light source luminance target value computation unit 5-2, as indicated by t₁₁ in FIG. 5(b). However, in this case, picture signal brightness correction (image correction) is not performed, as indicated by FIG. 5(c).

On the other hand, if the result of the determination in step S5 by the light source luminance change amount determination unit 5-4 as to whether the amount of change in light source luminance is more than the threshold value indicates that the amount of change in light source luminance (B2-B0) corresponding to an input image luminance change indicated at time t₂₀ of FIG. 5(a) is so large as to be more than the certain threshold value (Yes), the process goes on to step S7 where the light source correction target value computation unit 5-6 computes an image correction target value in accordance with the light source luminance. For example, when the input luminance value is X and the luminance value after correction is Y, an image correction target value Y is computed according to the following expression.

Y=aX (a is a coefficient of 1 or more)

Then, in step S8, the light source luminance target value B2 at the time of image correction is stored in the light source luminance target value storage unit 5-3 as the previous target value. In step S9, the drawing update instruction unit 5-7 feeds correction information from the control unit 5 to the image processing unit 3, instructing a drawing update. In step S10, the image processing unit 3 sends, based on the instruction from the drawing update instruction unit 5-7, a corrected picture signal for image display to the storage unit 15, and updates the picture signal in consideration of the brightness correction, as indicated by t₂₁ in FIG. 5(c), while in the display unit C, the luminance of the light source 11 is modified to the target value as indicated by t₂₁ in FIG. 5(c), as in step S6. The drawing timings are indicated by black dots.

According to the conventional technology, because of the absence of steps S5 and S6 of the process, the brightness correction and light source luminance modification processes are performed uniformly at both t₁₁ and t₂₁, regardless of the magnitude of the amount of change in light source luminance, as illustrated in FIG. 4. Thus, in FIG. 4 illustrating the conventional technology, the drawing process is performed a total of four times at the timings t₁₀, t₁₁, t₂₀, and t₂₁ indicated by black dots. In contrast, in FIG. 5, while a slightly darker portion than in the case of the conventional technology (indicated by dashed line L2) is caused in the apparent brightness, as indicated by L1 in FIG. 5(c), the drawing process is required for a total of three times at t₁₀, t₂₀, and t₂₁. Thus, there is the advantage that the number of times of drawing can be decreased compared with the conventional technology.

### Second Embodiment

The image processing and a display process according to a second embodiment of the present invention will be described.

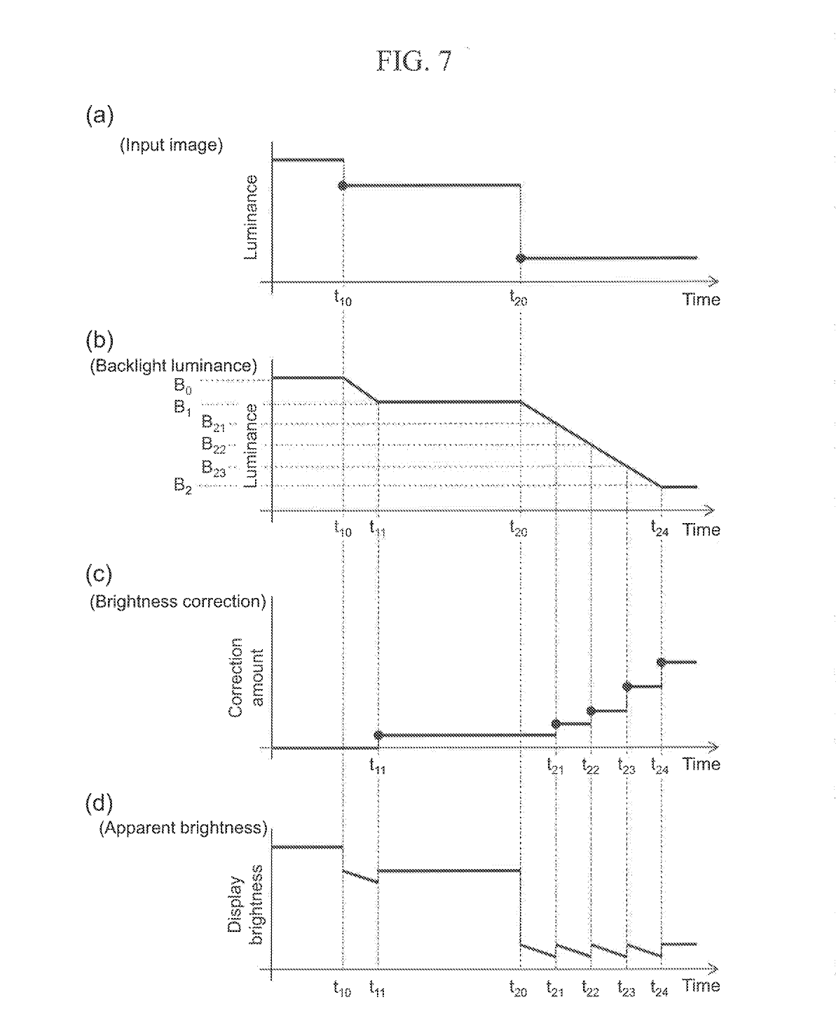

Herein, when the extent of change in backlight luminance is large, the time for the change is extended so as to make the change less visible. According to a general technology illustrated in FIG. 7, in order to make the amount of change in backlight luminance per unit time approximately the same, the time from t₁₀ to t₁₁ is taken for a change from B0 to B1, and for a change from B1 to B2 in which the backlight luminance is changed more greatly, intermediate targets of B21, B22, and B23 are placed so that the change takes place over the time from t₂₀ to t₂₄.

In this case, as indicated by FIG. 7(c), brightness correction is also performed similarly at four separate times (t₂₁, t₂₂, t₂₃, t₂₄), resulting in an increase in the total number of times of the drawing to 7.

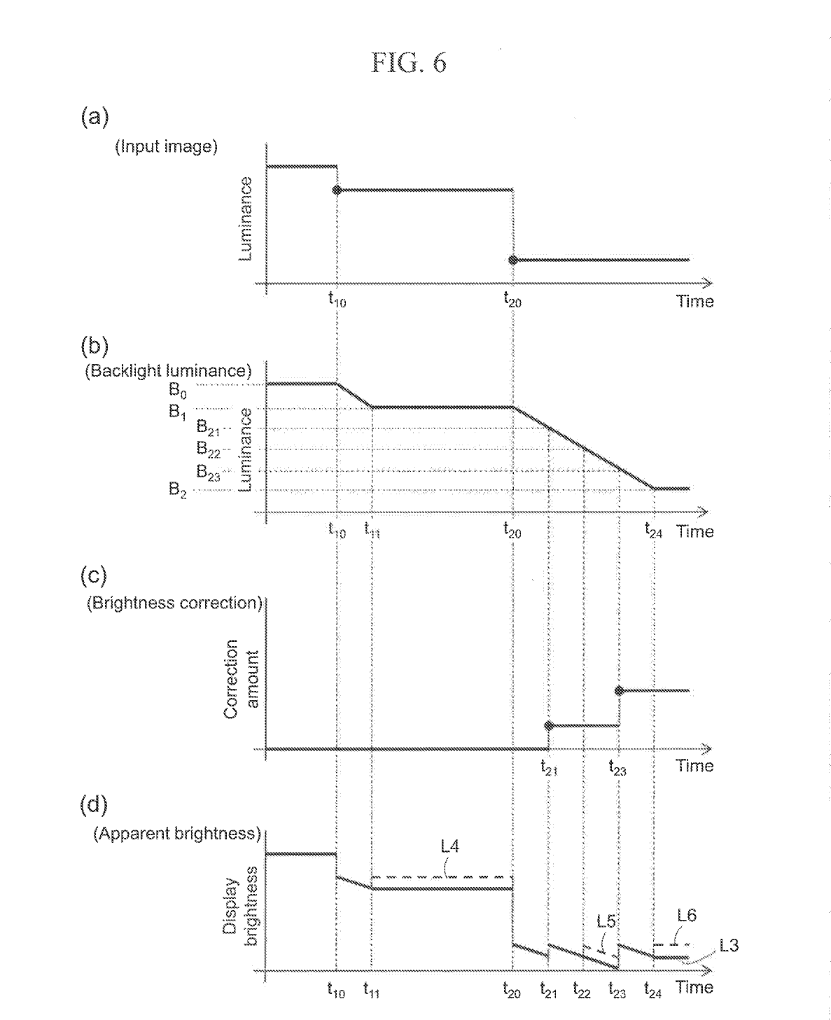

In contrast to the technology of FIG. 7, according to the technology of the present embodiment illustrated in FIG. 6, with reference to the backlight luminance at the point in time when brightness correction was performed last, brightness correction is performed only when the amount of change is more than a threshold value.

For example, the amount of change in light source luminance (B1-B0) corresponding to an input image luminance change indicated at t₁₀ of FIG. 6(a) is less than the threshold value, and therefore brightness correction is not performed at t₁₁ of FIG. 6(c). The first amount of change in light source luminance (B21-B0) corresponding to an input image luminance change indicated at t₂₀ in FIG. 6(a) is more than the threshold value, and therefore brightness correction is performed at t₂₁ of FIG. 6(c). Similarly thereafter, no brightness correction is performed at t₂₂ and t₂₄ of FIG. 6(c), while brightness correction is performed at t₂₃. In this way, the total number of times of the drawing can be limited to 4. Further, while the apparent brightness is slightly decreased as indicated by L3 in FIG. 6(d) compared with the conventional technology (indicated by dashed lines L4, L5, and L6 in FIG. 6(d)), there is the advantage that the number of times of the drawing can be decreased.

Thus, when the extent of change in backlight luminance is large, even if the time for the change is extended so that the change can be made less visible, there is obtained the advantage that the number of times of the drawing can be decreased compared with the conventional technology.

### Third Embodiment

The image processing and a display process according to a third embodiment of the present invention will be described.

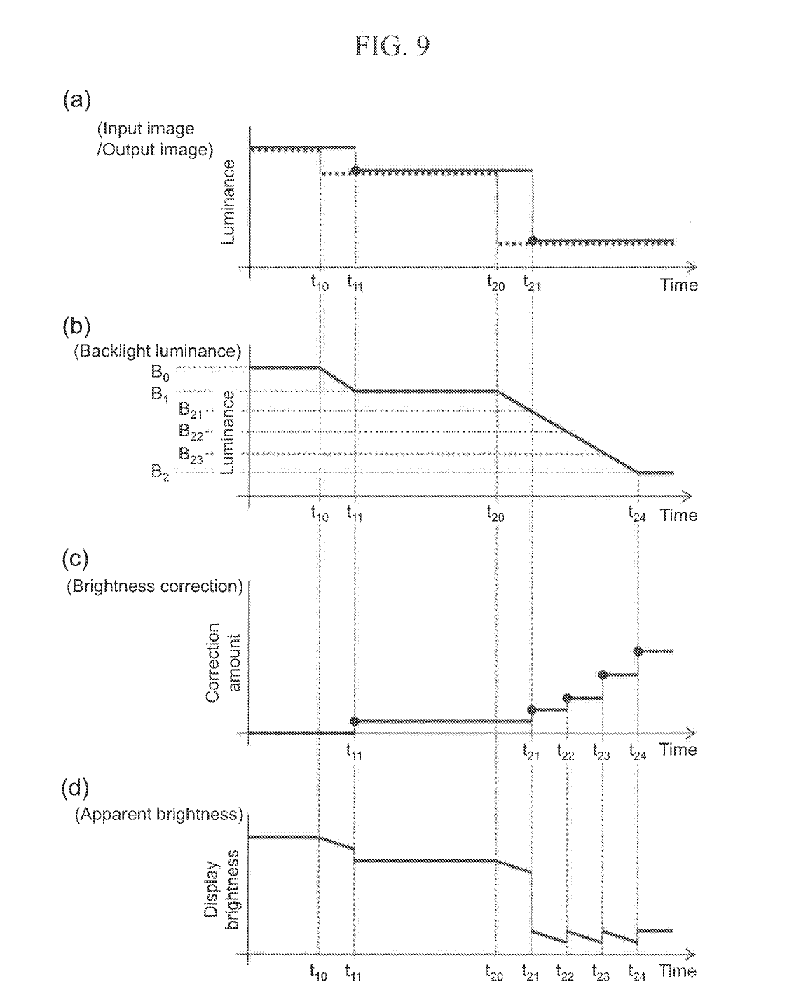

Here, the invention is applied to a system in which, in consideration of a delay in the change in backlight luminance with respect to a change in input image, the image is accumulated in a frame memory and output with a delay. According to a general technology illustrated in FIG. 9, as in the conventional technology corresponding to the second embodiment, the change from time t₂₀ to t₂₄ involving a greater change in backlight luminance is given a longer time than the change from time t₁₀ to t₁₁. In this case, the original image output and brightness correction can be performed at the same time, providing the feature that the corresponding drawings can be performed all at once (t₁₁ or t₂₁ in the figure). Namely, in this example, the drawing is performed a total of five times, of which three corresponds to the increase in the drawing due to correction.

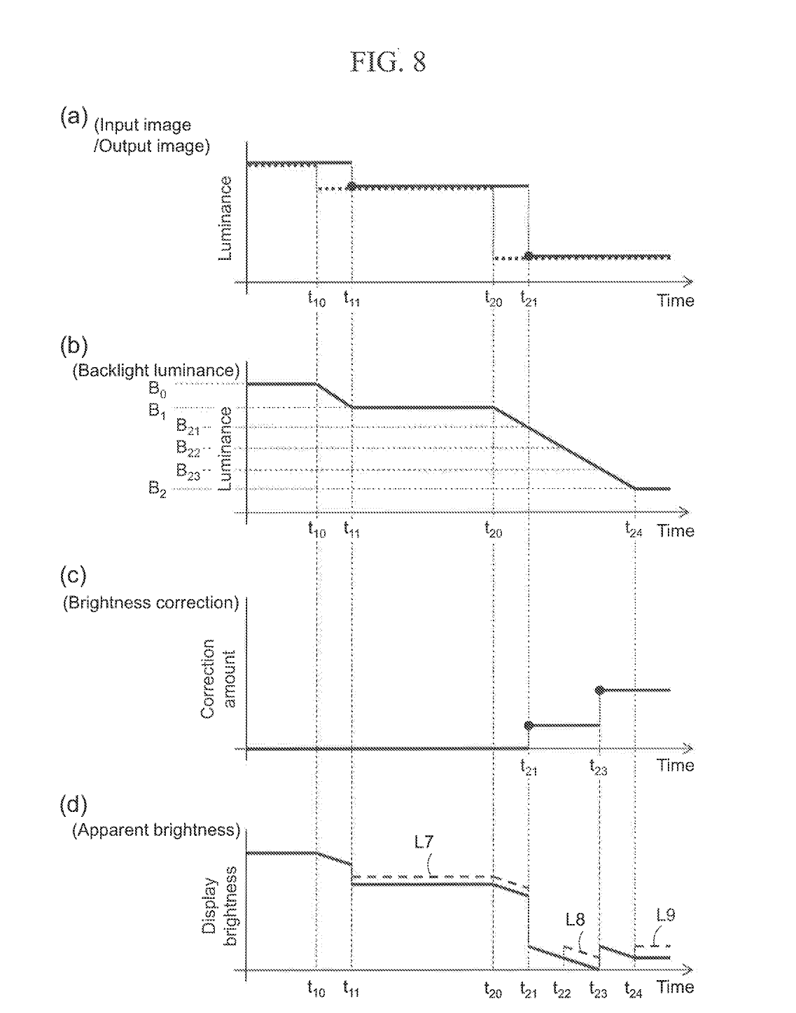

In contrast to the technology of FIG. 9, according to the technology of the present embodiment illustrated in FIG. 8, with reference to the backlight luminance at the point in time when brightness correction was performed last, brightness correction is performed only when the amount of change is more than a threshold value. For example, brightness correction for the input image luminance change at t₂₀ in FIG. 9(a) is performed only at t₂₁ and t₂₃ in FIG. 9(c). While the apparent brightness is slightly decreased as indicated by FIG. 8(d) compared with the conventional technology (indicated by dashed lines L8 and L9 in FIG. 8(d)), the advantage that the number of times of the drawing can be decreased can be obtained. In this case, the drawing needs to be performed a total of three times, of which only one corresponds to the increase in the drawing due to correction.

Thus, even in the system such that, in consideration of the delay in the change in backlight luminance with respect to an input image change, the image is accumulated in a frame memory and output with a delay, the advantage that the number of times of the drawing can be decreased compared with the conventional technology can be obtained.

### Fourth Embodiment

The image processing and a display process according to a fourth embodiment of the present invention will be described.

While this example is similar in principle to the case of the second embodiment, it contemplates a case where, with regard to a change in input image, a luminance change occurs twice with the same extent of change.

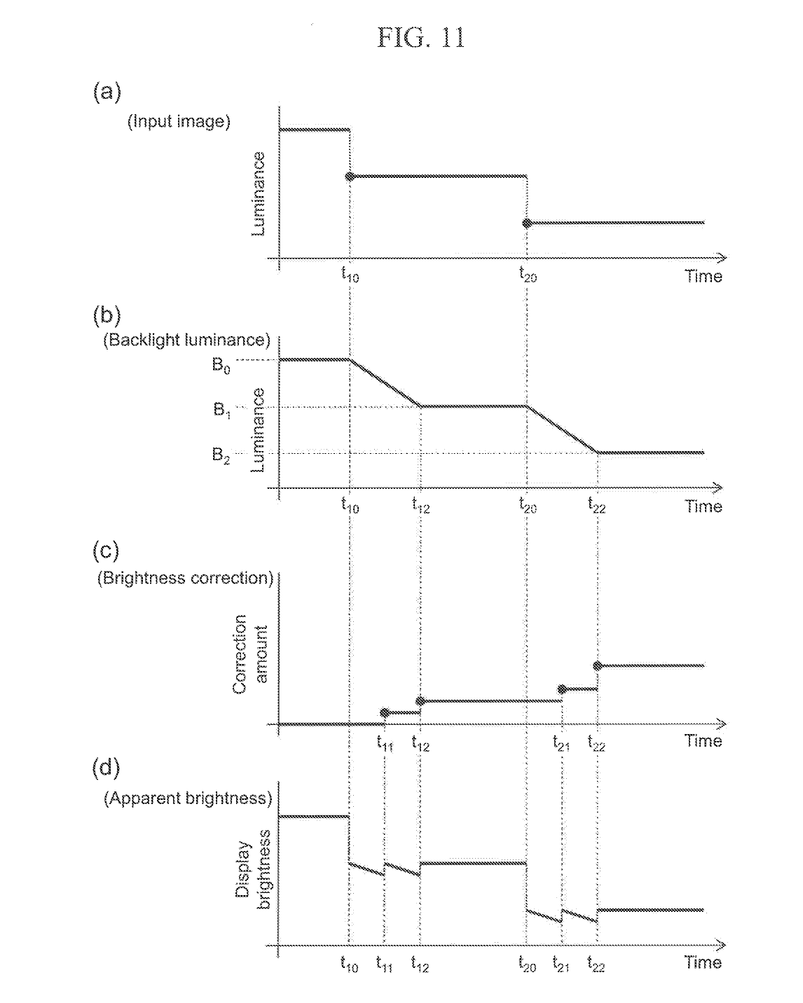

In a general example illustrated in FIG. 11, when luminance changes are caused at time t₁₀ and time t₂₀, according to the conventional technology of FIG. 11, the drawing for brightness correction is performed at t₁₁, t₁₂, t₂₁, and t₂₂. Thus, the drawing is performed a total of six times.

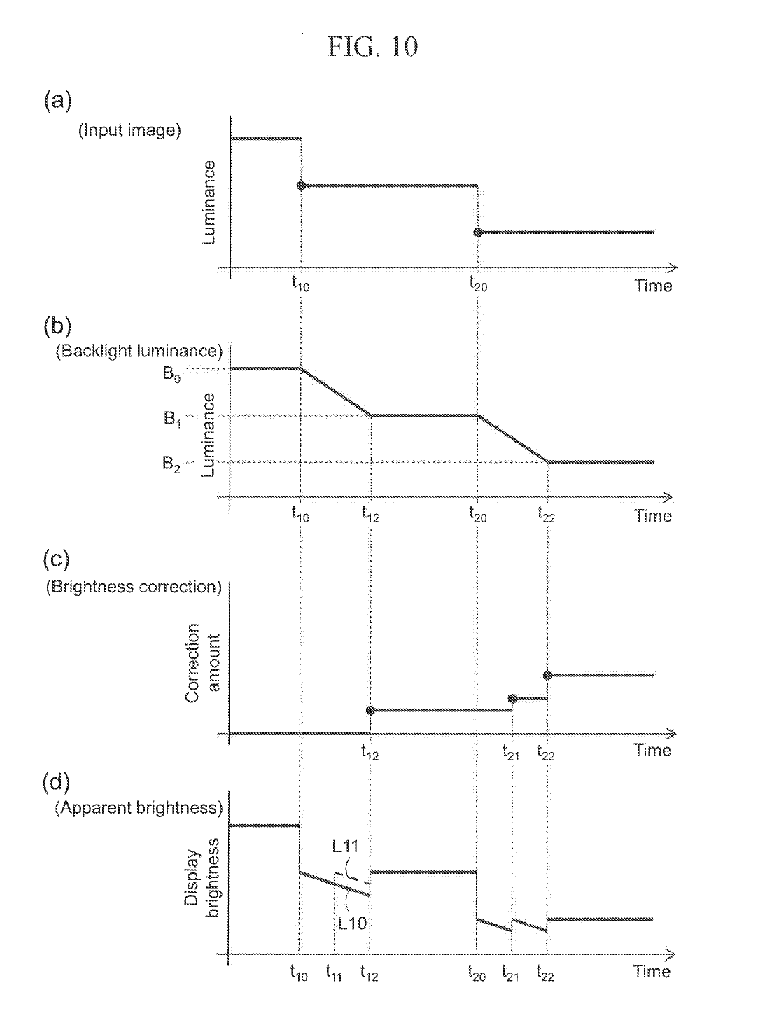

On the other hand, according to the present embodiment, as illustrated in FIG. 10, the backlight luminance change threshold value for determining whether brightness correction is to be performed is varied in accordance with the current backlight luminance value; namely, the threshold value is made variable. For example, when the backlight luminance value is large, the threshold value is increased, and when the backlight luminance value is small, the threshold value is also decreased. Thus, as illustrated in FIG. 10, for a change from t₁₀ where the backlight luminance value is large, no brightness correction is performed at t₁₁, for example, because the threshold value is also increased. On the other hand, for a change from t₂₀ where the backlight luminance value is small, brightness correction is performed at t₂₁, for example, because the threshold value is also decreased. In the figure, because the first luminance change is on the relatively high luminance side, the drawing is performed just once. For the second luminance change, because the change is on the lower brightness side, the drawing is performed twice.

In this way, the following display characteristics can be obtained.

1) As a feature of human visual properties, the greater the original physical quantity (herein luminance), the less readily perceivable its change becomes, and the smaller the physical quantity, the more readily perceivable its change becomes (Weber-Fechner law).

In view of this property, in a high luminance state where a change is not readily perceivable, the threshold value is increased so that correction takes place less often. On the other hand, in a low luminance state, because a change is more readily perceivable, the threshold value is decreased so that correction takes place more often. In this way, the display becomes more readily perceivable, thus delivering better visual quality.

2) When the electric power balance is considered, in the case of high luminance, the backlight luminance can be hardly decreased and not much of a power saving effect can be obtained, so that it is necessary to minimize an increase in power consumption by corrections. On the other hand, in the case of low luminance, a sufficient power saving effect can be obtained by a decrease in backlight luminance, so that the net power consumption is suppressed even if correction is performed and the drawing is performed.

In this case, too, there can be obtained the advantage that the number of times of drawing can be decreased compared with the conventional technology.

While, according to the present embodiment, an example provided with a memory for holding picture data in pixels has been described, the processing technology according to the present embodiment may also be applied to a configuration in which pixels are not provided with a memory. In this case, too, the processing burden caused by image correction performed when the luminance change is very small can be decreased.

The foregoing description of the embodiment with reference to configurations and the like illustrated in the attached drawings should not to be taken as limiting the present invention, and various changes may be made as long as the effect of the invention can be obtained. Various other modifications may be made without departing from the scope of the purpose of the present invention.

Various constituent elements of the present invention may be adopted or rejected as needed, and inventions provided with such adopted or rejected configurations may be included in the present invention.

A program for realizing the functions described with reference to the present embodiment may be recorded in a computer-readable recording medium, and the program recorded in the recording medium may be read and executed by a computer system so as to perform the processing in various units. The “computer system” herein includes hardware such as an OS or a peripheral device.

The “computer system” may include a web page providing environment (or display environment) when the WWW system is utilized.

The “computer-readable recording medium” may refer to a portable medium such as a flexible disc, a magnetooptic disc, a ROM, or a CD-ROM, or a storage unit built inside a computer system, such as a hard disk. The “computer-readable recording medium” may further include a medium that holds a program dynamically for a short period of time, such as a communication line in the case of transmission of the program via a network, such as the Internet, or a communication line, such as a telephone line, and a medium that holds a program for a certain time, such as a volatile memory inside the computer system providing a server or a client in the above case. The program may be configured to realize some of the above-described functions, or may be configured to realize the above-described functions in combination with a program already recorded in the computer system. At least some of the functions may be realized by hardware such as an integrated circuit.

### INDUSTRIAL APPLICABILITY

The present invention can be utilized for a display apparatus.

### REFERENCE SIGNS LIST

A Display apparatus
B Image processing apparatus
C Display unit
1 Image analysis unit
1a Luminance distribution computation unit
3 Image processing unit
5 Control unit
5-1 Light source luminance target value computation unit
5-2 Light source luminance change amount computation unit
5-3 Light source luminance target value storage unit
5-4 Light source luminance change determination unit
5-5 Threshold value storage unit
5-6 Image correction target value computation unit
5-7 Drawing update instruction unit
11 Light source
15 Storage unit
17 Display panel

All publications, patents, and patent applications mentioned herein are incorporated by reference herein in their entirety.

1-8. (canceled)

9. An image display apparatus comprising:
a display panel;
a light source configured to irradiate the display panel; and
a control unit,
wherein:
when a picture signal input to the image display apparatus is displayed on the display panel and controlled to have a target display brightness, the control unit is configured or programmed to modify a light source luminance defined by an amount of light emitted by the light source and to perform picture signal brightness correction so as to compensate for a modification of the light source luminance; and
when an amount of change in the light source luminance is smaller than a threshold value, the control unit is configured or programmed to decrease the light source luminance without performing the picture signal brightness correction.

10. The image display apparatus according to claim 9, wherein, when the amount of change in light source luminance is greater than the threshold value, the control unit is configured or programmed to decrease the light source luminance and perform the picture signal brightness correction.

11. The image display apparatus according to claim 9, wherein the light source luminance is modified for a period depending on the amount of change in light source luminance.

12. The image display apparatus according to claim 9, wherein the threshold value is variable depending on a current light source luminance value.

13. The image display apparatus according to claim 9, wherein the display panel is provided with a memory configured to hold picture data.

14. The image display apparatus according to claim 9, further comprising a memory in a picture signal output unit configured to hold picture data,
wherein a change in the picture signal and a change in the light source luminance is output in a synchronized manner.

15. An image display method in an image display apparatus including a display panel and a light source that irradiates the display panel,
the method comprising a control step of, when a picture signal input to the image display apparatus is displayed on the display panel and controlled to have a target display brightness, modifying an amount of light emitted by the light source and performing picture signal brightness correction so as to compensate for a modification of the light source luminance,
wherein the control step includes a step of decreasing the light source luminance without performing the picture signal brightness correction when an amount of change in light source luminance is smaller than a threshold value.

16. A non-transitory computer-readable medium including a computer program configured to cause a computer to execute the image display method according to claim 15.

17. The image display apparatus according to claim 10, wherein the threshold value is variable depending on a current light source luminance value.

18. The image display apparatus according to claim 11, wherein the threshold value is variable depending on a current light source luminance value.

19. The image display apparatus according to claim 10, wherein the display panel is provided with a memory configured to hold picture data.

20. The image display apparatus according to claim 11, wherein the display panel is provided with a memory configured to hold picture data.

21. The image display apparatus according to claim 12, wherein the display panel is provided with a memory configured to hold picture data.

22. The image display apparatus according to claim 10, further comprising a memory in a picture signal output unit configured to hold picture data,
wherein a change in the picture signal and a change in the light source luminance is output in a synchronized manner.

23. The image display apparatus according to claim 11, further comprising a memory in a picture signal output unit configured to hold picture data,
wherein a change in the picture signal and a change in the light source luminance is output in a synchronized manner.

24. The image display apparatus according to claim 12, further comprising a memory in a picture signal output unit configured to hold picture data,
wherein a change in the picture signal and a change in the light source luminance is output in a synchronized manner.

25. The image display apparatus according to claim 13, further comprising a memory in a picture signal output unit configured to hold picture data,
wherein a change in the picture signal and a change in the light source luminance is output in a synchronized manner.
